(19) United States
(12) Patent Application Publication
(10) Pub. No.: US 2010/0170847 A1
(43) Pub. Date: Jul. 8, 2010

(54) MEMBRANE CLEANING USING AN AIRLIFT PUMP

(76) Inventors: Fufang Zha, New South Wales (AU); Wenjun Liu, King of Prussia, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/602,155

(22) PCT Filed: May 29, 2008
(86) PCT No.: PCT/AU08/00761

§ 371 Date: Nov. 29, 2009

Related U.S. Application Data
(60) Provisional application No. 60/940,518, filed on May 29, 2007.

(51) Int. Cl. B01D 65/02; B01D 65/06; B01D 65/04; B01D 65/08; C02F 3/06

(52) U.S. Cl. 210/636; 210/321.69

(57) ABSTRACT

A membrane module (5) comprising a plurality of porous membranes (6), a gas-lift pump apparatus (11) in fluid communication with the module (5) for providing a two-phase gas/liquid flow such that, in use, the two-phase gas/liquid flow moves past the surfaces of the membranes (6) to dislodge fouling materials therefrom. The gas-lift pump device (11) includes: a vertically disposed chamber (12) of predetermined dimensions submersed to a predetermined depth in a liquid medium (15), wherein the chamber (12) has an upper portion (10) in fluid communication with the membrane module (5) and a lower portion (13) in fluid communication with the liquid medium (15); a source of gas (14) in fluid communication with the chamber (12) at a predetermined location therein for flowing gas at a predetermined rate into the chamber (12) to produce the two-phase gas/liquid mixture and to produce a flow of the mixture into the membrane module (5). The dimensions of the chamber (12), the submersion depth of the chamber (12), the rate of flow of gas and the location of gas flow into the chamber (12) are selected to optimize a flow rate of the two phase gas/liquid mixture into the module (5).

### TECHNICAL FIELD

The present invention relates to membrane filtration systems and, more particularly, to apparatus and related methods to effectively clean the membranes used in such systems by means of a mixture of gas and liquid.

### BACKGROUND OF THE INVENTION

The importance of membranes for treatment of wastewater is growing rapidly. It is now well known that membrane processes can be used as an effective tertiary treatment of sewage and provide quality effluent. However, the capital and operating cost can be prohibitive. With the arrival of submerged membrane processes where the membrane modules are immersed in a large feed tank and filtrate is collected through suction applied to the filtrate side of the membrane or through gravity feed, membrane bioreactors combining biological and physical processes in one stage promise to be more compact, efficient and economic. Due to their versatility, the size of membrane bioreactors can range from household (such as septic tank systems) to the community and large-scale sewage treatment.

The success of a membrane filtration process largely depends on employing an effective and efficient membrane cleaning method. Commonly used physical cleaning methods include backwash (backpulse, backflush) using a liquid permeate or a gas or combination thereof, membrane surface scrubbing or scouring using a gas in the form of bubbles in a liquid. Typically, in gas scouring systems, a gas is injected, usually by means of a blower, into a liquid system where a membrane module is submerged to form gas bubbles. The bubbles so formed then travel upwards to scrub the membrane surface to remove the fouling substances formed on the membrane surface. The shear force produced largely relies on the initial gas bubble velocity, bubble size and the resultant of forces applied to the bubbles.

For the membrane filtration of feed water containing a high concentration of suspended solids, such as in membrane bioreactors, besides an efficient gas scouring cleaning process, membrane surface refreshment is also of vital importance to minimize the solid concentration polarization.

The fluid transfer in this approach is limited to the effectiveness of the gas lifting mechanism. To enhance the scrubbing effect, more gas has to be supplied. However, this method consumes large amounts of energy. Furthermore, in an environment of high concentration of solids, the solid concentration polarization near the membrane surface becomes significant during filtration where clean filtrate passes through membrane and a higher solid-content retentate is left, leading to an increased membrane resistance. Some of these problems have been addressed by the use of two-phase flow to clean the membrane.

A membrane filtration system with gas scouring typically relies on “airlift effect” to achieve membrane surface refreshment and cleaning of the membrane systems. In order to achieve a high lifting flowrate, the tank containing the membrane has to be divided into a riser zone and a down-corner zone. This requires the membrane modules have to be spaced apart to provide sufficient down-corner zones for the “airlift effect” to operate. The packing density of the membranes/modules in a membrane tank is thus limited and a comparatively large footprint is required to achieve an effective “airlift effect”.

Other gas scouring systems use a different process by employing a jet to deliver a liquid flow into the fiber bundles of a membrane module. Such a process achieves a positive refreshment of the membrane surface without the need for down-flow zones. Therefore membrane modules can be arranged tightly to save membrane tank's space and volume. Such the systems have the disadvantage of requiring jets for each module and energy consuming pumping systems for forcing the liquid through the jet.

### DISCLOSURE OF THE INVENTION

It is an object of the present invention to overcome or ameliorate at least one of the disadvantages of the prior art, or to provide a useful alternative.

According to one aspect, the present invention provides a method of cleaning a surface of a membrane using a liquid medium with gas bubbles mixed therein, including the steps of providing a two phase gas/liquid mixture flow along said membrane surface to dislodge fouling materials therefrom, wherein the step of providing said two phase gas/liquid mixture includes:

providing a vertically disposed chamber of predetermined dimensions submersed to a predetermined depth in said liquid medium, wherein said chamber has an upper portion in fluid communication with said membrane and a lower portion in fluid communication with said liquid medium,

flowing gas at a predetermined rate into said chamber at a predetermined location therein to form a gas-lift pump to produce said two-phase gas/liquid mixture and to produce a flow of said mixture along the surface of said membrane;

selecting the dimensions of said chamber, the submersion depth of said chamber, the rate of flow of gas and the location of gas flow into said chamber to optimise a flow rate of the two phase gas/liquid mixture along said membrane surface.

Optionally, an additional source of bubbles may be provided in said liquid medium by means of a blower or like device. The gas used may include air, oxygen, gaseous chlorine, ozone, nitrogen, methane or any other gas suitable for a particular application. Air is the most economical for the purposes of scrubbing and/or aeration. Gaseous chlorine may be used for scrubbing, disinfection and enhancing the cleaning efficiency by chemical reaction at the membrane surface. The use of ozone, besides the similar effects mentioned for gaseous chlorine, has additional features, such as oxidizing DBP precursors and converting non-biodegradable NOM's to biodegradable dissolved organic carbon. In some applications, for example, an anaerobic biological environment or a non-biological environment where oxygen or oxidants are undesirable, nitrogen may be used, particularly where the feed tank is closed with ability to capture and recycle the nitrogen.

According to a second aspect, the present invention provides a membrane module comprising a plurality of porous membranes, a gas-lift pump apparatus in fluid communication with said module for providing a two-phase gas/liquid flow such that, in use, said two-phase gas/liquid flow moves past the surfaces of said membranes to dislodge fouling materials therefrom, said gas-lift pump device including:

a vertically disposed chamber of predetermined dimensions submersed to a predetermined depth in a liquid medium, wherein said chamber has an upper portion in fluid communication with said membrane module and a lower portion in fluid communication with said liquid medium,

a source of gas in fluid communication with said chamber at a predetermined location therein for flowing gas at a predetermined rate into said chamber to produce said two-phase gas/liquid mixture and produce a flow of said mixture into said membrane module;

wherein the dimensions of said chamber, the submersion depth of said chamber, the rate of flow of gas and the location of gas flow into said chamber are selected to optimize a flow rate of the two phase gas/liquid mixture into said module.

In one form of the invention, the gas-lift pump device is coupled to a set or plurality of membrane modules. Preferably, said chamber comprises a tube. For preference, said two phase gas/liquid flow also serves to reduce solid concentration polarization of the membrane. Preferably, the optimization comprises maximizing the feed liquid flow rate. The flow of gas may be essentially continuous or intermittent to produce an essentially continuous or intermittent two phase gas/liquid flow.

For preference, the membranes comprise porous hollow fibers, the fibers being fixed at each end in a header, the lower header having one or more holes formed therein through which the two-phase gas/liquid flow is introduced. The holes can be circular, elliptical or in the form of a slot. The fibers are normally sealed at one end, typically the lower end and open at their other end, typically the upper end, to allow removal of filtrate, however, in some arrangements, the fibers may be open at both ends to allow removal of filtrate from one or both ends. The sealed ends of the fibers may be potted in a potting head or left unpotted. The fibers are preferably arranged in cylindrical arrays or bundles. Optionally, the module can have a shell or screen surrounding it. It will be appreciated that the cleaning process described is equally applicable to other forms of membrane such flat or plate membranes.

For further preference, the membranes comprise porous hollow fibers, the fibers being fixed at each end in a header to form a sub-module. A set of sub-modules is assembled to form a module or a cassette. Between sub-modules, one or more spaces are left to allow the passage or distribution of the two-phase gas/liquid mixture into the sub-modules.

According to one preferred form, the present invention provides a method of removing fouling materials from the surface of a plurality of porous hollow fiber membranes mounted and extending longitudinally in an array to form a membrane module, the method comprising the step of providing a uniformly distributed two-phase gas/liquid flow past the surfaces of said membranes, wherein the step of providing said two phase gas/liquid mixture flow includes:

providing a vertically disposed chamber of predetermined dimensions submersed to a predetermined depth in a liquid medium, wherein said chamber has an upper portion in fluid communication with said membrane module and a lower portion in fluid communication with said liquid medium,

flowing gas at a predetermined rate into said chamber at a predetermined location therein to produce said two-phase gas/liquid mixture and to produce a flow of said mixture past the surfaces of said membranes;

electing the dimensions of said chamber, the submersion depth (submergence) of said chamber, the rate of flow of gas and the location of gas flow into said chamber to optimise a flow rate of the two-phase gas/liquid mixture past said membrane surfaces.

According to a third aspect the present invention provides a membrane module comprising a plurality of porous hollow fiber membranes, the fiber membranes being fixed at each end in a header, one header having one or more openings formed therein through which a two phase gas/liquid flow is introduced for cleaning the surfaces of said hollow fiber membranes, a gas-lift pump apparatus in fluid communication with said module for providing said two-phase gas/liquid flow, said gas-lift pump device including:

a vertically disposed chamber of predetermined dimensions submersed to a predetermined depth in a liquid medium, wherein said chamber has an upper portion in fluid communication with the openings of said membrane module and a lower portion in fluid communication with said liquid medium,

a source of gas in fluid communication with said chamber at a predetermined location therein for flowing gas at a predetermined rate into said chamber to produce said two-phase gas/liquid mixture and produce a flow of said mixture into said membrane module;

wherein the dimensions of said chamber, the submersion depth of said chamber, the rate of flow of gas and the location of gas flow into said chamber are selected to optimize a flow rate of the two phase gas/liquid mixture into said module.

Preferably, said membranes are arranged in close proximity to one another and mounted to prevent excessive movement therebetween.

For preference, the module may be encapsulated in a substantially solid or liquid/gas impervious tube and connected to the gas-lift pump device so as to retain the two-phase gas/liquid flow within the module.

### BRIEF DESCRIPTION OF THE DRAWINGS

Preferred embodiments of the invention will now be described, by way of example only, with reference to the accompanying drawings in which:

FIG. 1 shows a simplified schematic elevation view of one embodiment of the invention;

FIG. 2 shows a similar view to FIG. 1 of a further embodiment of the invention using a number of sets of membrane modules;

FIG. 3 shows the embodiment of FIG. 2 used in a bank of membrane modules;

FIG. 4 shows a simplified schematic sectional elevation view of an embodiment of the invention used in the providing examples of operational characteristics of the invention;

FIG. 5 shows a graph of average liquid flow versus normalized gas flow for different gas injection points in the pump chamber;

FIG. 6 shows a graph of average liquid flow versus normalized gas flow for various pump diameters; and

FIG. 7 shows a comparison of average liquid flow versus normalized gas flow for a conventional gas scouring configuration and a configuration according to embodiments of the invention.

### DESCRIPTION OF PREFERRED EMBODIMENTS

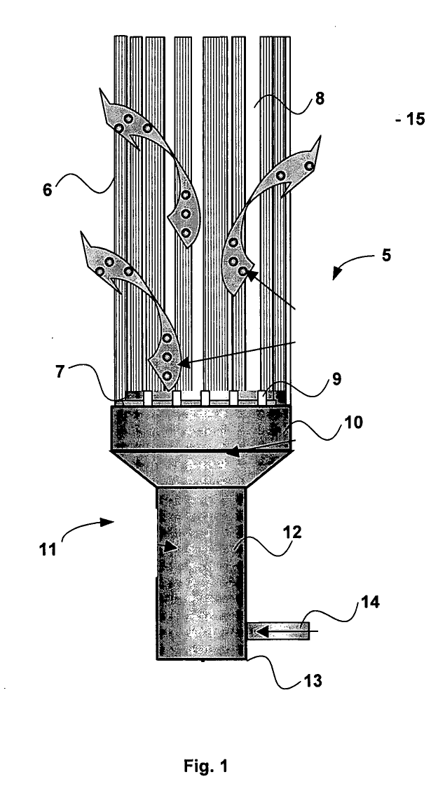

Referring to FIG. 1 of the drawings, this embodiment includes a membrane module 5 having a plurality of permeable hollow fiber membranes bundles 6 mounted in and extending from a lower potting head 7. In this embodiment, the bundles are partitioned to provide spaces 8 between the bundles 6. It will be appreciated that any desirable arrangement of membranes within the module 5 may be used. A number of openings 9 are provided in the lower potting head 7 to allow flow of fluids therethrough from the distribution chamber 10 positioned below the lower potting head 7.

A gas-lift pump device 11 is provided below the distribution chamber 10 and in fluid communication therewith. The gas-lift pump device 11 includes a pump chamber 12, typically a tube or pipe, open at its lower end 13 and having a gas inlet port 14 located part-way along its length.

In use, the module 5 is immersed in liquid feed 15 and source of pressurized gas is applied to gas inlet port 14 at a pressure equivalent to the depth of submergence of the pump chamber 12. The pressurized gas produces bubbles in feed liquid 15 within the pump chamber 12 which rise through the chamber to produce a two-phase gas/liquid flow and displace the liquid within the pump chamber 12 upwardly. The two-phase gas/liquid feed liquid mixture flows upward through the pump chamber 12, then through the distribution chamber 10 and into the base of the membrane module 5.

The gas normally used for membrane scouring in this embodiment is also employed for operating gas-lift pump and pushes the gas/liquid mixture into the membrane module. With the gas-lift pump arrangement shown in this embodiment both membrane cleaning and membrane surface refreshment can be achieved simultaneously. During the membrane filtration cycle, the solid concentration polarization is minimized with such effective surface refreshment.

With a specific configuration of a membrane module or an assembly of modules, there exists an optimal gas-lift pump configuration that lifts maximum liquid at certain amount of gas supply. The lift effect on the liquid is not restricted by the membrane module packing density in the tank, overcoming one of the disadvantages of the existing membrane systems. The volume of gas/liquid mixture lifted in a particular module configuration is also dependent on the length of the module(s), with the amount of flow increasing with the length of the module(s). Accordingly, the maximum liquid lifted may be further improved by efficient design of the module(s) and membrane tank dimensions.

The design of an efficient gas-lift pump is dependent on a number of factors, such as specific membrane configuration, module submergence, pump dimensions, gas flowrate to be supplied to and location of gas inlet point.

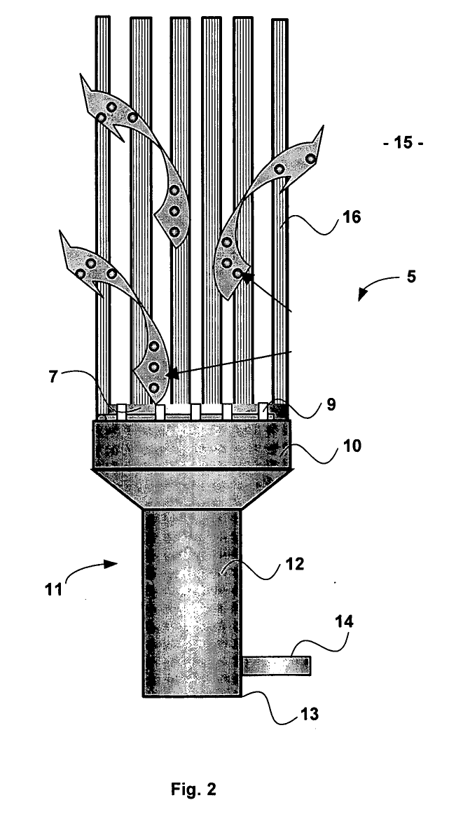

FIG. 2 shows a similar arrangement to the embodiment of FIG. 1 where a gas-lift pump device 11 and distribution chamber 10 are attached to assembly of separate modules 16 and a two-phase gas/liquid flow is supplied to each of the modules 16.

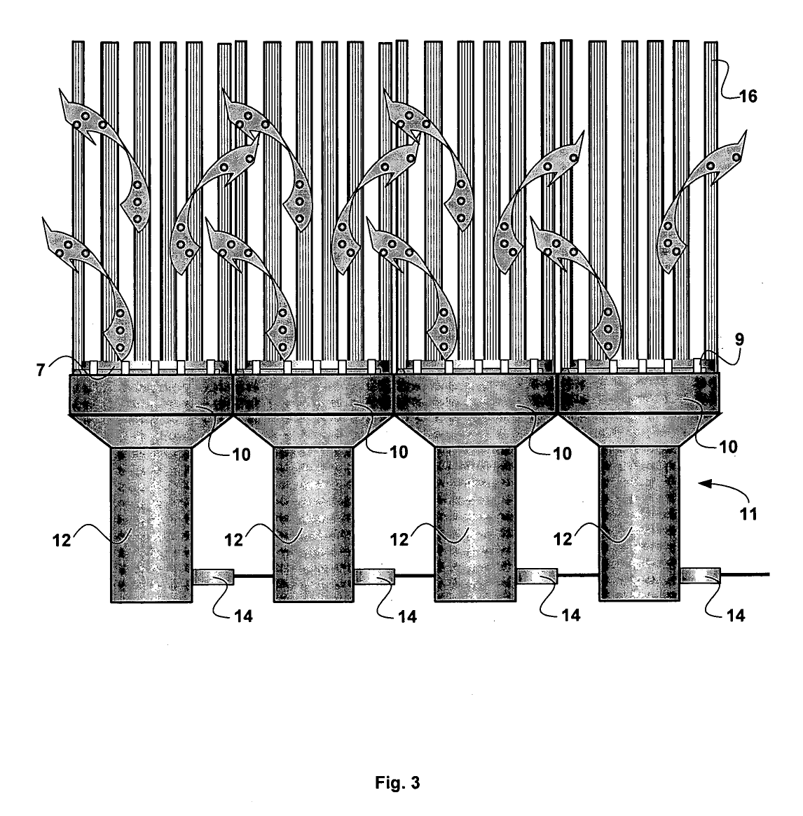

FIG. 3 again illustrates an arrangement of modules 16 of the type shown in the embodiment of FIG. 2 positioned in a tank 17, where the modules 16 may be packed closely without impacting on membrane cleaning and surface refreshment.

### Examples

When membranes are in filtration mode, the suspended solid concentration in the vicinity of the membranes is higher than the bulk phase. It is necessary for the feed liquid flow into the membrane module to be several times that of the filtrate flow removed, i.e. Q_{L}=nQ. In membrane bioreactors, n is normally >3, and typically 5-6, to avoid extremely high suspended solid concentration on the membrane surface. Accordingly, it is preferable to operate the filtration system at a higher liquid feed flowrate Q_{L}, but a higher feed flow rate requires higher energy consumption. By employing gas-lift pump arrangements shown in the above embodiments, it is possible to achieve a high liquid flow at a fixed gas flowrate by optimizing the parameters of the gas-lift pump.

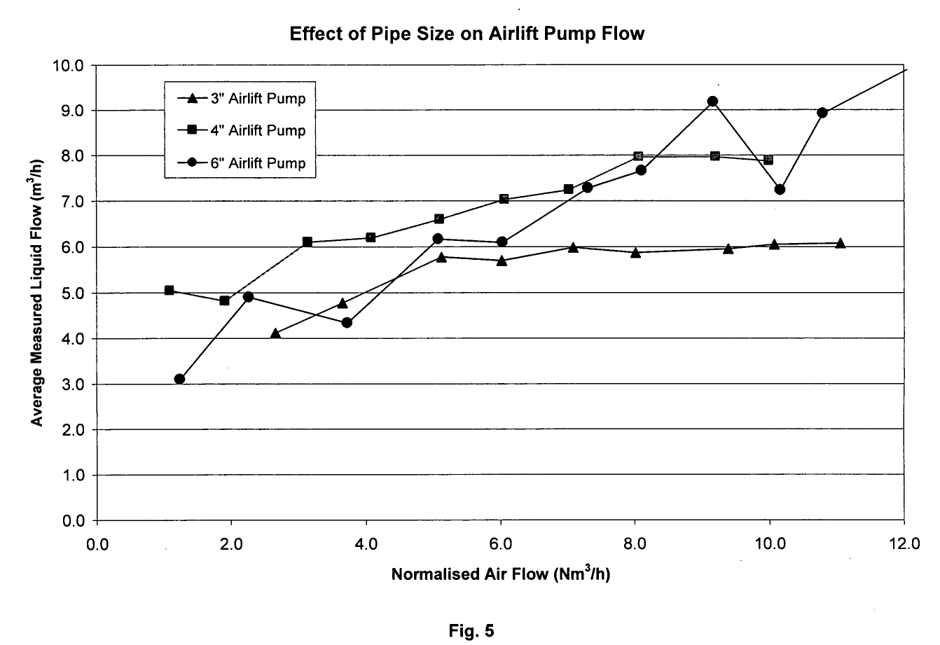

FIG. 5 shows the experimental configuration for a gas-lift pump test. A membrane filtration module 5 with hollow fibers (38 m² membrane area) was immersed in water. The water depth was 2240 mm from the bottom of the module 5 to the top water surface 18. Beneath the module 5 a gas-lift pipe 12 was attached to the module 5 through an adapter or distribution chamber 10. The length and the diameter of the pipe 12 are directly related to the lifted liquid flowrate at a certain gas (in this case air) flowrate.

A first test conducted was conducted to compare the effect of different submergence depths of the module 5 on the liquid flowrate. A 4″ gas-lift pipe 12 was connected to the module 5 via the adapter 10. Compressed air was injected to a gas inlet port 14 of the gas-lift pump 11 and the air flowrate was measured with a mass flowmeter (not shown). The liquid flowrate lifted by air was measured with a paddle wheel flowmeter (not shown) located below the gas inlet port 14. Two different air injection points were tested: The distance L between air inlet port to the bottom of the module including adapter was set at 120 and 210 mm. The graph of FIG. 5 illustrates the liquid flow provided by gas-lift pump device 11 at various normalized air flowrates. It is clear that a longer gas-lift pipe, that is a deeper submergence, achieves a higher liquid flow.

Although a longer gas-lift pipe is beneficial to a higher liquid flow because of an increased submergence, it is limited by the depth of the tank in which the membranes are positioned. For a certain type of membrane modules, a deeper tank means more liquid volume and will require more volume of chemical cleaning solution during a chemical clean. To apply a gas-lift pump to membrane modules, the length of the gas-lift pipe is typically between 100 to 1000 mm, more typically from 100 to 500 mm.

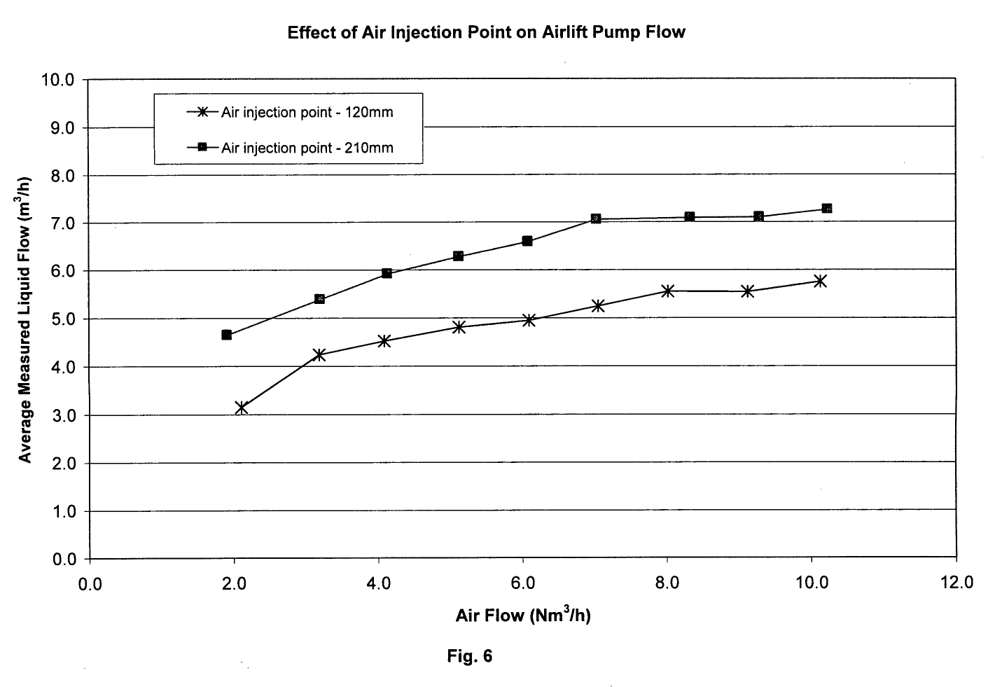

For a certain types of membrane system, the parameter of the gas-lift pump that can be practically adjusted or optimized is the diameter of the gas-lift pipe. Under the same configuration and operating conditions as described above different gas-lift pump pipe diameters were compared for the lifted liquid flowrates. The pipe length L was fixed at 210 mm. FIG. 6 shows the liquid flowrates for 3″, 4″ and 6″ diameter pipe sizes. At the air flowrate ≦8 Nm³/hr the 4″ diameter gas-lift pipe provided the highest liquid flow.

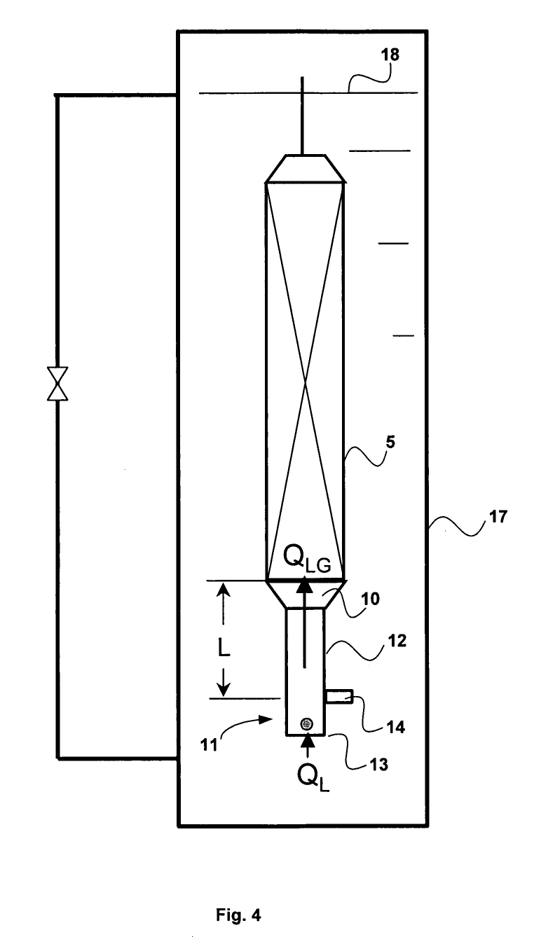

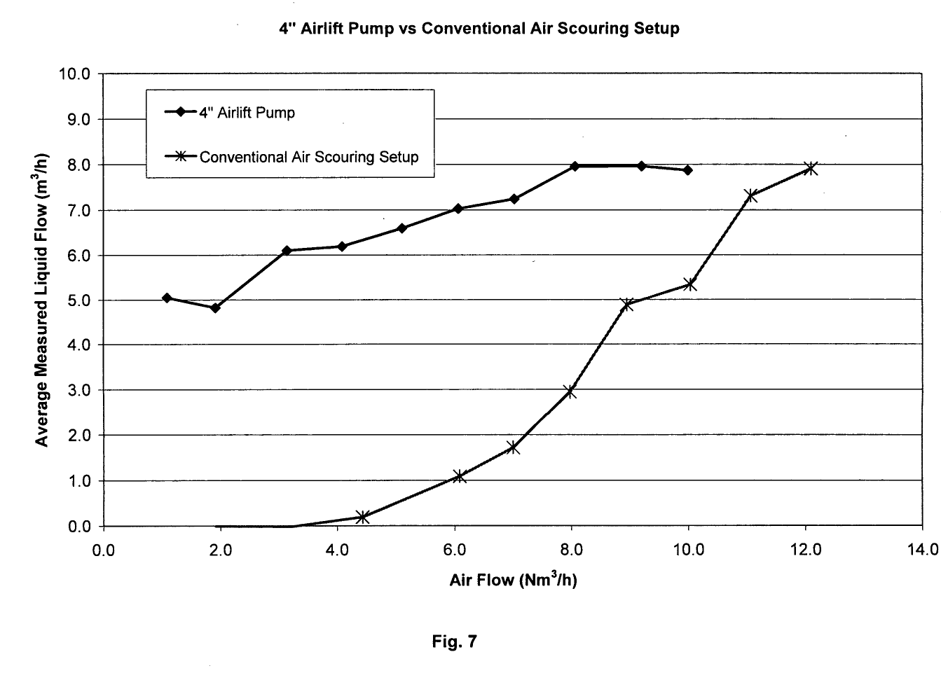

In order to compare the use of a gas-lift pump performance to the conventional gas-lift effect, the module configuration with gas-lift pump in FIG. 4 was changed to a conventional gas lift configuration using an air diffuser positioned below the membrane module 5. The air diffuser's submergence was kept the same as the gas-lift pump device 11. The graph of FIG. 7 shows the comparison of the liquid flowrates provided using the two different configurations. The graph shows the 4″ diameter gas-lift pump provided a much higher liquid flow at the air flowrate ≦10 Nm³/hr than the conventional configuration.

It will be appreciated that further embodiments and exemplifications of the invention are possible without departing from the spirit or scope of the invention described.

1. A method of cleaning a surface of a membrane using a liquid medium with gas bubbles mixed therein, including the steps of providing a two phase gas/liquid mixture flow along said membrane surface to dislodge fouling materials therefrom, wherein the step of providing said two phase gas/liquid mixture comprises the steps of:
providing a vertically disposed chamber of predetermined dimensions submersed to a predetermined depth in said liquid medium, wherein said chamber has an upper portion in fluid communication with said membrane and a lower portion in fluid communication with said liquid medium,
flowing gas at a predetermined rate into said chamber at a predetermined location therein to form a gas-lift pump to produce said two-phase gas/liquid mixture and to produce a flow of said mixture along the surface of said membrane; and
selecting the dimensions of said chamber, the submersion depth of said chamber, the rate of flow of gas and the location of gas flow into said chamber to optimise a flow rate of the two phase gas/liquid mixture along said membrane surface.

2. A method according to claim 1 further including providing an additional source of bubbles in said liquid medium.

3. A method according to claim 1 wherein the flow of gas is essentially continuous to provide an essentially continuous flow of said two-phase gas/liquid mixture.

4. A method according to claim 1 wherein the flow of gas is intermittent to provide an intermittent flow of said two-phase gas/liquid mixture.

5. A membrane module comprising a plurality of porous membranes, a gas-lift pump apparatus in fluid communication with said module for providing a two-phase gas/liquid flow such that, in use, said two-phase gas/liquid flow moves past the surfaces of said membranes to dislodge fouling materials therefrom, said gas-lift pump device comprising:
a vertically disposed chamber of predetermined dimensions submersed to a predetermined depth in a liquid medium, wherein said chamber has an upper portion in fluid communication with said membrane module and a lower portion in fluid communication with said liquid medium,
a source of gas in fluid communication with said chamber at a predetermined location therein for flowing gas at a predetermined rate into said chamber to produce said two-phase gas/liquid mixture and to produce a flow of said mixture into said membrane module; and
wherein the dimensions of said chamber, the submersion depth of said chamber, the rate of flow of gas and the location of gas flow into said chamber are selected to optimize a flow rate of the two phase gas/liquid mixture into said module.

6. A membrane module according to claim 5 wherein the gas-lift pump device is coupled to a set or plurality of membrane modules.

7. A method according to claim 5 wherein the flow of gas is essentially continuous to provide an essentially continuous flow of said two-phase gas/liquid mixture.

8. A method according to claim 5 wherein the flow of gas is intermittent to provide an intermittent flow of said two-phase gas/liquid mixture.

9. A membrane module according to claim 5 wherein said chamber comprises a tube.

10. A membrane module according to claim 5 wherein the optimization comprises maximizing the feed liquid flow rate.

11. A membrane module according to claim 5 wherein the membranes comprise porous hollow fibers, the fibers being fixed at each end in a header, the lower header having one or more holes formed therein through which the two-phase gas/liquid flow is introduced.

12. A membrane module according to claim 5 wherein the membranes comprise porous hollow fibers, the fibers being fixed at each end in a header to form a sub-module.

13. A membrane module according to claim 12 wherein a number of sub-modules are assembled to form a module or a cassette.

14. A membrane module according to claim 13 wherein one or more spaces are provided between said sub-modules to allow the passage or distribution of the two-phase gas/liquid mixture into the sub-modules.

15. A method of removing fouling materials from the surface of a plurality of porous hollow fiber membranes mounted and extending longitudinally in an array to form a membrane module, the method comprising the step of providing a uniformly distributed two-phase gas/liquid flow past the surfaces of said membranes, wherein the step of providing said two phase gas/liquid mixture flow comprises the steps of:
providing a vertically disposed chamber of predetermined dimensions submersed to a predetermined depth in a liquid medium, wherein said chamber has an upper portion in fluid communication with said membrane module and a lower portion in fluid communication with said liquid medium,
flowing gas at a predetermined rate into said chamber at a predetermined location therein to produce said two-phase gas/liquid mixture and to produce a flow of said mixture past the surfaces of said membranes; and
selecting the dimensions of said chamber, the submersion depth (submergence) of said chamber, the rate of flow of gas and the location of gas flow into said chamber to optimise a flow rate of the two-phase gas/liquid mixture past said membrane surfaces.

16. A method according to claim 15 wherein the flow of gas is essentially continuous to provide an essentially continuous flow of said two-phase gas/liquid mixture.

17. A method according to claim 15 wherein the flow of gas is intermittent to provide an intermittent flow of said two-phase gas/liquid mixture.

18. A membrane module comprising a plurality of porous hollow fiber membranes, the fiber membranes being fixed at each end in a header, one header having one or more openings formed therein through which a two phase gas/liquid flow is introduced for cleaning the surfaces of said hollow fiber membranes, a gas-lift pump apparatus in fluid communication with said module for providing said two-phase gas/liquid flow, said gas-lift pump device comprising:
a vertically disposed chamber of predetermined dimensions submersed to a predetermined depth in a liquid medium, wherein said chamber has an upper portion in fluid communication with the openings of said membrane module and a lower portion in fluid communication with said liquid medium,
a source of gas in fluid communication with said chamber at a predetermined location therein for flowing gas at a predetermined rate into said chamber to produce said two-phase gas/liquid mixture and to produce a flow of said mixture into said membrane module; and
wherein the dimensions of said chamber, the submersion depth of said chamber, the rate of flow of gas and the location of gas flow into said chamber are selected to optimize a flow rate of the two phase gas/liquid mixture into said module.

19. A membrane module according to claim 18 wherein the module is at least partially surrounded by a substantially solid or liquid/gas impervious tube and connected to the gas-lift pump device so as to retain the two-phase gas/liquid flow within the module.

20. A membrane module according to claim 18 wherein the flow of gas is essentially continuous to provide an essentially continuous flow of said two-phase gas/liquid mixture.

21. A membrane module according to claim 18 wherein the flow of gas is intermittent to provide an intermittent flow of said two-phase gas/liquid mixture.
